(19) United States
(12) Patent Application Publication
(10) Pub. No.: US 2025/0187328 A1
(43) Pub. Date: Jun. 12, 2025

(54) PRESSURE ADJUSTMENT APPARATUS, DROPLET EJECTION APPARATUS, PRESSURE ADJUSTMENT METHOD, AND STORAGE MEDIUM

(71) Applicant: Konica Minolta, Inc., Tokyo (JP)

(72) Inventor: Shigetaka KUROSU, Tokyo (JP)

(21) Appl. No.: 18/962,140

(22) Filed: Nov. 27, 2024

(30) Foreign Application Priority Data
Dec. 8, 2023 (JP) 2023-207945

(51) Int. Cl. B41J 2/045; B41J 2/175

(52) U.S. Cl. CPC B41J 2/04501; B41J 2/17556; B41J 2/17596

(57) ABSTRACT

A pressure adjustment apparatus includes: a gas channel configured to form an enclosed space and including a suction-side gas channel at a suction side of a pneumatic pump and a discharge-side gas channel at a discharge side of the pneumatic pump; the pneumatic pump configured to send gas from the suction side to the discharge side; atmospheric relief valves including a suction-side atmospheric relief valve provided to the suction-side gas channel and a discharge-side atmospheric relief valve provided to the discharge-side gas channel; and a hardware processor. In driving the pneumatic pump, the hardware processor controls opening and closing of the atmospheric relief valves to firstly adjust a pressure in the enclosed space formed in one of the suction-side gas channel and the discharge-side gas channel and secondly adjust a pressure in another of the suction-side gas channel and the discharge-side gas channel.

### CROSS-REFERENCE TO RELATED APPLICATIONS

The entire disclosure of Japanese Patent Application No. 2023-207945 filed on Dec. 8, 2023 is incorporated herein by reference in its entirety.

### TECHNICAL FIELD

The present invention relates to a pressure adjustment apparatus, a droplet ejection apparatus, a pressure adjustment method, and a storage medium.

### DESCRIPTION OF RELATED ART

There is known a droplet ejection apparatus configured to eject liquid droplets onto recording surfaces of recording media to record images. A droplet ejection apparatus includes a tank containing ink and sends the ink to an inkjet head by a pump. The ink sent to the inkjet head is ejected from nozzles at appropriate timing, so that an image is formed on the recording medium.

For an ink supply system of such a droplet ejection apparatus, maintenance, such as circulation and ejection of ink, is performed by adjusting the pressure in the tank. For example, Japanese Unexamined Patent Publication No. 2011-235605 describes an ink supplying apparatus configured to selectively switch pressurization targets by connecting chambers on the pump side via an electromagnetic valve, so that ejection maintenance time is shortened. Furthermore, for example, International Publication No. 2016/076082 describes a droplet ejection apparatus configured to perform maintenance of both circulation and ejection by an air pump to downsize the apparatus.

According to the invention of JP 2011-235605A, a high-output air supply pump having a large flow rate is required to simultaneously perform maintenance of multiple large-sized tanks. On the other hand, to perform both the circulation maintenance and the ejection maintenance as in the invention of WO2016076082, an air supply pump having a large air capacity is required. Otherwise, it is difficult to precisely control the pressures in the tanks in the circulating maintenance. Therefore, the apparatus cannot be downsized.

The present invention has been made in view of such circumstances. An object of the present invention is to provide a pressure adjustment apparatus, a droplet ejection apparatus, a pressure adjustment method, and a storage medium that allow downsizing of the apparatus and precise pressure control.

### SUMMARY OF THE INVENTION

To achieve at least one of the abovementioned objects, according to an aspect of the present invention, a pressure adjustment apparatus includes: a gas channel configured to form an enclosed space, the gas channel including a suction-side gas channel at a suction side of a pneumatic pump and a discharge-side gas channel at a discharge side of the pneumatic pump; the pneumatic pump provided to the gas channel and configured to send gas from the suction side to the discharge side; atmospheric relief valves including at least one suction-side atmospheric relief valve and at least one discharge-side atmospheric relief valve, the suction-side atmospheric relief valve being provided to the suction-side gas channel and configured to open and close the suction-side gas channel to atmosphere, the discharge-side atmospheric relief valve being provided to the discharge-side gas channel and configured to open and close the discharge-side gas channel to atmosphere; and a hardware processor, wherein in driving the pneumatic pump, the hardware processor controls opening and closing of the atmospheric relief valves to firstly adjust a pressure in the enclosed space formed in one of the suction-side gas channel and the discharge-side gas channel and secondly adjust a pressure in another of the suction-side gas channel and the discharge-side gas channel.

According to another aspect of the present invention, there is provided a pressure adjustment method for a pressure adjustment apparatus that includes: a gas channel configured to form an enclosed space, the gas channel including a suction-side gas channel at a suction side of a pneumatic pump and a discharge-side gas channel at a discharge side of the pneumatic pump; the pneumatic pump provided to the gas channel and configured to send gas from the suction side to the discharge side; and atmospheric relief valves including at least one suction-side atmospheric relief valve and at least one discharge-side atmospheric relief valve, the suction-side atmospheric relief valve being provided to the suction-side gas channel and configured to open and close the suction-side gas channel to atmosphere, the discharge-side atmospheric relief valve being provided to the discharge-side gas channel and configured to open and close the discharge-side gas channel to atmosphere, wherein the method includes firstly adjusting a pressure in the enclosed space formed in one of the suction-side gas channel and the discharge-side gas channel and secondly adjusting a pressure in another of the suction-side gas channel and the discharge-side gas channel by controlling opening and closing of the atmospheric relief valves in driving the pneumatic pump.

According to another aspect of the present invention, there is provided a non-transitory computer-readable storage medium storing a program for a computer of a pressure adjustment apparatus that includes: a gas channel configured to form an enclosed space, the gas channel including a suction-side gas channel at a suction side of a pneumatic pump and a discharge-side gas channel at a discharge side of the pneumatic pump; the pneumatic pump provided to the gas channel and configured to send gas from the suction side to the discharge side; and atmospheric relief valves including at least one suction-side atmospheric relief valve and at least one discharge-side atmospheric relief valve, the suction-side atmospheric relief valve being provided to the suction-side gas channel and configured to open and close the suction-side gas channel to atmosphere, the discharge-side atmospheric relief valve being provided to the discharge-side gas channel and configured to open and close the discharge-side gas channel to atmosphere, wherein the program causes the computer to firstly adjust a pressure in the enclosed space formed in one of the suction-side gas channel and the discharge-side gas channel and secondly adjust a pressure in another of the suction-side gas channel and the discharge-side gas channel by controlling opening and closing of the atmospheric relief valves in driving the pneumatic pump.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention, wherein:

FIG. 1 is a side sectional view of an inkjet recording apparatus;

FIG. 2 is a schematic configuration diagram of a liquid delivery section;

FIG. 3 is a block diagram of the inkjet recording apparatus;

FIG. 4 is a flowchart of an ejection maintenance process;

FIG. 5A is a schematic diagram of the liquid delivery section when an enclosed space is pressurized;

FIG. 5B is a schematic view of the liquid delivery section when the second tank is pressurized;

FIG. 6 is a flowchart of a circulation maintenance process;

FIG. 7A is a schematic diagram of the liquid delivery section when the enclosed space is pressurized;

FIG. 7B is a schematic diagram of the liquid delivery section when a negative pressure is created in a first tank;

FIG. 8 is a graph showing the speed of creating a negative pressure in the first tank when the enclosed space is pressurized and when the enclosed space is not pressurized;

FIG. 9A is a graph showing a relationship between (i) a time chart of a liquid delivery pump, a pneumatic pump, and atmospheric relief valves and (ii) pressure values in the first tank and the second tank when the enclosed space is not pressurized;

FIG. 9B is a graph showing a relationship between (i) a time chart of the liquid delivery pump, the pneumatic pump, and the atmospheric relief valves and (ii) pressure values in the first tank and the second tank when the enclosed space is pressurized;

FIG. 10A is a graph showing a relationship between (i) a time chart of the pneumatic pump and the atmospheric relief valves and (ii) pressure values in the first tank and the enclosed space when the first atmospheric relief valve is closed before driving the pneumatic pump;

FIG. 10B is a graph showing a relationship between (i) a time chart of the pneumatic pump and the atmospheric relief valves and (ii) pressure values in the first tank and the enclosed space when the first atmospheric relief valve is closed after a predetermined period elapses from the start of driving the pneumatic pump; and

FIG. 10C is a graph showing a relationship between (i) a time chart of the pneumatic pump and the atmospheric relief valves and (ii) pressure values in the first tank and the enclosed space when the first atmospheric relief valve is closed after a predetermined period longer than in FIG. 10B elapses from the start of driving the pneumatic pump.

### DETAILED DESCRIPTION

Hereinafter, a droplet discharge apparatus according to an embodiment of the present invention will be described in detail with reference to the drawings. However, the scope of the invention is not limited to the illustrated examples. In the following description, components having the same functions and configurations are denoted by the same reference numerals, and the description thereof will be omitted.

### [Overall Configuration of Inkjet Recording Apparatus]

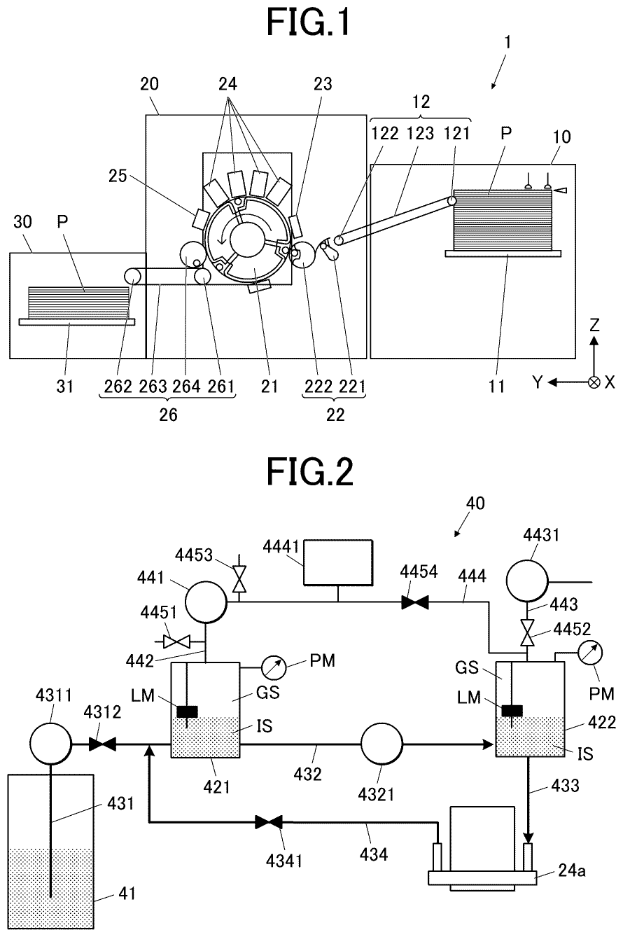

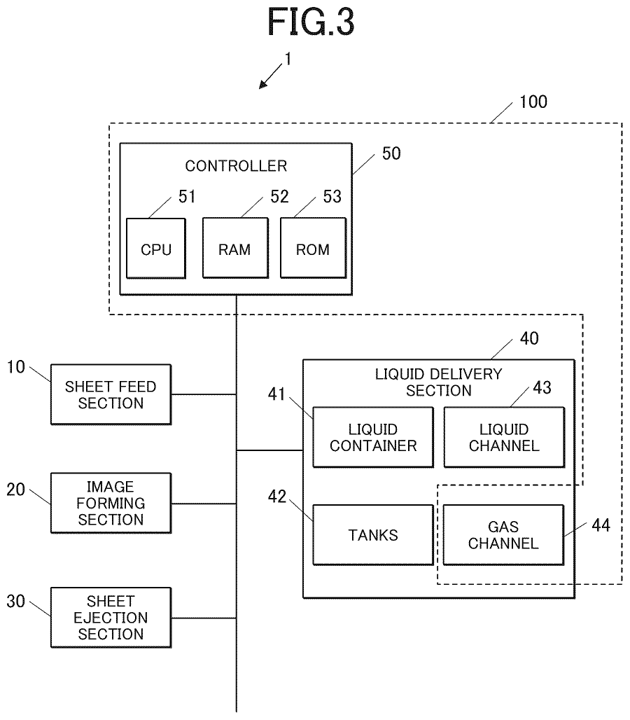

FIG. 1 is a side cross-sectional view of a schematic configuration of an inkjet recording apparatus 1 as an embodiment of a liquid droplet ejection apparatus of the present invention. The inkjet recording apparatus 1 includes a sheet feed section 10, an image forming section 20, a sheet ejection section 30, a liquid delivery section 40 (see FIG. 2), and a controller 50 (hardware processor) (see FIG. 3).

Hereinafter, an X direction, a Y direction, and a Z direction refer to the directions illustrated in FIG. 1. Further, in the description below, the X direction, the Y direction, and the Z direction correspond to a width direction, a conveyance direction, and a height direction, respectively.

### (Sheet Feed Section)

The sheet feed section 10 stores recording media P before image formation. The sheet feed section 10 conveys the recording media P to the image forming section 20 under the control of the controller 50. The sheet feed section 10 includes a sheet feed tray 11 and a conveyance section 12.

### {Sheet Feed Tray}

The sheet feed tray 11 is a plate member that stores the recording media P. The sheet feed tray 11 is provided such that one or more recording media P can be placed thereon. The sheet feed tray 11 moves up and down according to the amount of the recording media P placed thereon. The sheet feed tray 11 is held at a position where the uppermost recording medium P is conveyed by the conveyance section 12 in the vertical movement direction.

### {Conveyance Section}

The conveyance section 12 conveys the recording media P from the sheet feed tray 11 to the image forming section 20. The conveyance section 12 includes a conveyance mechanism. The conveyance mechanism drives a belt 123 to convey the recording media P on the belt 123. The belt 123 has a ring shape, and the inner side of the ring is supported by rollers 121 and 122.

The conveyance section 12 includes a supply section. The supply section delivers the uppermost recording medium P placed on the sheet feed tray 11 onto the belt 123. The conveyance section 12 conveys the recording medium P along the belt 123 by the supply section.

### (Image Forming Section)

The image forming section 20 performs a recording operation on the recording media P under the control of the controller 50 in cooperation with the liquid delivery section 40. The image forming section 20 includes an image forming drum 21, a handover unit 22, a sheet heater 23, head units 24, an irradiation section 25, and a delivery section 26.

### {Image Forming Drum}

The image forming drum 21 holds the recording medium P along its cylindrical outer peripheral surface and rotates to carry the recording medium P. The carrying surface of the image forming drum 21 faces the sheet heater 23, the head units 24, and the irradiation section 25, which perform image forming processing on the carried recording medium P.

### {Handover Unit}

The handover unit 22 is provided between the conveyance section 12 and the image forming drum 21. The handover unit 22 includes a claw 221 and a handover drum 222.

The claw 221 is a cylindrical part that holds one end of the recording medium P conveyed by the conveyance section 12. The handover drum 222 guides the recording medium P held by the claw 221.

The handover unit 22 picks up the recording medium P on the conveyance section 12 with the claw 221 and places the recording medium P along the outer peripheral surface of the handover drum 222. Thus, the handover unit 22 passes the recording medium P to the image forming drum 21.

### {Sheet Heating Section}

The sheet heater 23 includes, for example, a heating wire and generates heat by energization. The sheet heater 23 is controlled by the controller 50 to generate heat so that the recording medium P passing in the vicinity of the sheet heater 23 has a predetermined temperature. The sheet heater 23 is provided in the vicinity of the outer peripheral surface of the image forming drum 21 and on the upstream side of the head units 24 in the conveyance direction of the recording medium P.

A temperature sensor (not illustrated) is provided near the sheet heater 23. With the temperature sensor, the controller 50 detects the temperature around the sheet heater 23. Based on the detected temperature, the controller 50 controls heat generation of the sheet heater 23.

### {Head Unit}

The head units 24 form an image by ejecting ink onto the recording medium P. The head units 24 correspond to the colors of C (cyan), M (magenta), Y (yellow), and K (black), respectively. In FIG. 1, the head units 24 corresponding to the respective colors of Y, M, C, and K are provided in this order from the upstream of the conveyance direction.

The head units 24 of the present embodiment have a length (width) that covers the entire width of the recording medium P in the width direction. That is, the inkjet recording apparatus 1 according to the present embodiment is a line head type. Each of the head units 24 includes inkjet heads 24a (see FIG. 2) arranged in the width direction, which are droplet ejection heads.

The number of head units 24 provided in the image forming section 20 may be less than four or greater than four. A single inkjet head 24a may constitute the head unit 24. The inkjet recording apparatus 1 may be a serial head type that forms an image by scanning, in the width direction, the head unit 24 that is shorter than the recording medium P in the width direction.

The ink ejected by the head units 24 is, for example, ultraviolet curable ink. The ultraviolet curable ink is a gel-like ink that undergoes a phase change between a gel state and a liquid (sol) state according to the temperature when ultraviolet rays are not irradiated by the irradiation section 25. The ultraviolet curable ink has a phase change temperature of, for example, about 40 to 100° C., and is uniformly liquefied (solated) by being heated to the phase change temperature or higher. On the other hand, the ultraviolet curable ink is gelled at normal room temperature, that is, at around 0 to 30° C.

### {Irradiation Section}

The irradiation section 25 includes, for example, a fluorescent tube such as a low-pressure mercury lamp. The irradiation section 25 emits energy rays such as ultraviolet rays by lighting up the fluorescent tube. The irradiation section 25 is provided in the vicinity of the outer peripheral surface of the image forming drum 21. The irradiation section 25 is positioned in the downstream of the head units 24 in the conveyance direction of the recording medium P. The irradiation section 25 emits energy rays to the recording medium P on which ink has been ejected. By the effect of the energy rays, the ink on the recording medium P is cured.

The fluorescent tube that emits ultraviolet rays is not limited to the low-pressure mercury lamp. The fluorescent tube may be a mercury lamp having an operating pressure of a few hundred Pa to 1 MPa, for example. The fluorescent tube may be a light source usable as a bactericidal lamp, for example, a cold-cathode tube, an ultraviolet laser light source, a metal halide lamp, a light-emitting diode, or the like. The fluorescent tube is desirably a power saving light source capable of emitting ultraviolet light with higher illuminance. The fluorescent tube is, for example, a light emitting diode or the like. The energy rays are not limited to the ultraviolet rays and may be energy rays having a property of curing the ink depending on the property of the ink. The light source is determined depending on the energy rays.

Although the head units 24 jet the ultraviolet curable ink in the above description, the invention is not limited thereto. The ink ejected by the head units 24 may be water-based ink or ink having other physical properties.

### {Delivery Section}

The delivery section 26 includes a conveyance mechanism. The conveyance mechanism drives a ring-shaped belt 263 to convey the recording medium P. The inner side of the belt 263 is supported by rollers 261 and 262. The delivery section 26 includes a cylindrical passing roller 264. The passing roller 264 passes the recording medium P from the image forming drum 21 to the conveyance mechanism. The delivery section 26 conveys and sends the recording medium P passed on the belt 263 by the passing roller 264 to the sheet ejection section 30.

### (Sheet Ejection Section)

The recording medium P on which an image has been formed by the image forming section 20 is ejected to the sheet ejection section 30. The sheet ejection section 30 includes a plate-shaped sheet ejection tray 31. The recording medium P sent out from the image forming section 20 by the delivery section 26 is placed on the sheet ejection tray 31. The sheet ejection section 30 stores the recording medium P until a user takes out the recording medium P.

### (Liquid Delivery Section)

FIG. 2 shows a schematic configuration of the liquid delivery section 40. FIG. 2 shows only one inkjet head 24a, and other inkjet heads 24a are omitted. The liquid delivery section 40 includes a liquid container 41, tanks 42, a liquid channel 43, and a gas channel 44.

### {Liquid Container}

The liquid containers 41 contain ink of the respective colors to be supplied to the components of the liquid delivery section 40. Although omitted in FIG. 2, the liquid containers 41 are provided for the individual colors of ink. The ink is supplied to the first tank 421 via the first liquid channel 431 by the supply pump 4311 when a supply valve 4312, which is described later, is opened. The entire body of the liquid container 41 is replaceable, and the liquid container 41 is attachable to and detachable from the first liquid channel 431 regardless of the operation state of the supply pump 4311.

### {Tanks}

The tanks 42 include, for example, a first tank 421 and a second tank 422. The tanks 42 each include a liquid storage portion IS and a gas storage portion GS. The tanks 42 store the ink supplied from the liquid container 41 in the liquid storage portion IS and supply the ink to the inkjet head 24a. The gas storage portion GS is located above the ink liquid surface and stores gas, such as air. The capacity of the tanks 42 is smaller than or substantially equal to the capacity of the liquid container 41.

Each of the tanks 42 is provided with a pressure measurer PM that is a pressure gauge capable of measuring the internal pressure. The pressure measurer PM acquires a pressure value in the tank 42 and outputs the pressure value to the controller 50 one by one.

Further, each of the tanks 42 is provided with a liquid level measurer LM. The liquid level measurer LM is a float sensor, for example. The liquid level measurer LM acquires measurement data regarding the position of the ink liquid surface in the tank 42 and outputs the measurement data to the controller 50. The controller 50 acquires the amount of ink remaining in each of the tanks 42 from the measurement data and appropriately sends ink from the liquid container 41 or the first tank 421 on the upstream side in the liquid sending direction. The amount of ink remaining in the liquid storage portion IS is adjusted so that the capacity of the gas storage portion GS of each of the first tank 421 and the second tank 422 is between 150 ml and 250 ml, for example.

Furthermore, each of the tanks 42 is provided with an ink heater (not illustrated) that keeps ink in the tank at an appropriate temperature. The ink heater is constituted of a heater, a heat transfer member that transfers heat of the heater, and the like. As the heater constituting the ink heater, a heating wire that generates Joule heat by energization is used, for example. As the heat transfer member constituting the ink heater, a member having a high heat conductivity, such as a heat conductive plate formed of various metals (alloys) is used, for example.

### [First Tank]

The first tank 421 temporarily stores ink supplied from the liquid container 41. The liquid delivery section 40 includes the first tank 421 to reduce pressure changes caused by pulsation, which is generated when the supply pump 4311 supplies ink from the liquid container 41.

### [Second Tank]

The second tank 422 temporarily stores ink delivered from the first tank 421. An appropriate negative pressure is applied to the second tank 422 by a back pressure pump 4431, which is described later. Thus, ink is prevented from leaking from the inkjet head 24a in a normal state. With such a configuration, the second tank 422 need not be disposed below the inkjet head 24a to control the back pressure of the nozzles of the inkjet head 24a by the difference in hydraulic heads. Therefore, the second tank 422 can be disposed at any position with respect to the inkjet head 24a, and the liquid delivery section 40 and the inkjet recording apparatus 1 can be downsized.

### {Liquid Channel}

The liquid channel 43 is an ink channel that connects the liquid container 41 through to the inkjet head 24a. The liquid channel 43 includes a first liquid channel 431, a second liquid channel 432, a third liquid channel 433, and a fourth liquid channel 434. It is preferable that the liquid channel 43 be resistant to ink. The liquid channel 43 has a hollow annular tube structure.

### [First Liquid Channel]

The first liquid channel 431 communicates with the liquid container 41 and the first tank 421. The first liquid channel 431 is provided with a supply pump 4311 and a supply valve 4312. Based on the measurement result of the liquid level measurer LM of the first tank 421, the controller 50 opens the supply valve 4312, which is an electromagnetic valve, and drives the supply pump 4311. Thus, the controller 50 delivers ink in the liquid container 41 into the first tank 421.

### [Second Liquid Channel]

The second liquid channel 432 communicates with the first tank 421 and the second tank 422. The second liquid channel 432A is provided with a liquid delivery pump 4321. The liquid delivery pump 4321 is, for example, a diaphragm pump. Under the control of the controller 50, based on the measurement result of the liquid level measurer LM of the second tank 422, the liquid delivery pump 4321 delivers ink in the first tank 421 into the second tank 422.

Although omitted in FIG. 2, the second liquid channel 432 may be provided with a known deaeration module that deaerates ink passing through the second liquid channel 432. In a case where the second liquid channel 432 is provided with the deaeration module, the first tank 421 and the second tank 422 may communicate with each other via another liquid channel so that ink can be circulated between the first tank 421 and the second tank 422.

### [Third Liquid Channel and Fourth Liquid Channel]

The third liquid channel 433 communicates with the second tank 422 and the inlet of the inkjet head 24a. The fourth liquid channel 434 communicates the outlet of the inkjet head 24a with the first liquid channel 431 (or the first tank 421). The fourth liquid channel 434A is provided with a circulation valve 4341 which is an electromagnetic valve. Under the control of the controller 50, the circulation valve 4341 is opened in an ink circulation maintenance process, which will be described later.

### {Gas Channel}

The gas channel 44 has a hollow annular tube structure. The gas channel 44 communicates with the gas storage portions GS of the tanks 42. The gas channel 44 includes a pneumatic pump 441, a first gas channel 442, a second gas channel 443, a third gas channel 444, and an atmospheric relief valve 445

### {Pneumatic Pump}

The pneumatic pump 441 is under the control of the controller 50 and is normally not driven at the time of image formation. The pneumatic pump 441 is driven to suck the gas on the first gas channel 442 side and discharge the gas to the third gas channel 444 side at the time of maintenance. By the driving of the pneumatic pump 441, an ejection maintenance process is performed. In the ejection maintenance process, the second tank 422 is pressurized, and ink is ejected from the inkjet head 24a. Further, by the driving of the pneumatic pump 441, a circulation maintenance process is performed. In the circulation maintenance process, the first tank 421 is depressurized, and ink is delivered from the outlet of the inkjet head 24a to the first tank 421. Details of the ejection maintenance process and the circulation maintenance process will be described later.

In the present embodiment, the pneumatic pump 441 is a high-output pump having a high flow rate. In the ejection maintenance process, the pneumatic pump 441 pressurizes the second tank 422 to eject ink from the inkjet head 24a. Specifically, the flow rate of the pneumatic pump 441 is equal to or greater than two liters/min, for example. It is preferable that the pneumatic pump 441 be a diaphragm pump in terms of durability, cost, size, and variations.

### [First Gas Channel]

The first gas channel 442 is on the suction side of the pneumatic pump 441 and communicates with the gas storage portion GS of the first tank 421.

### [Second Gas Channel]

The second gas channel 443 communicates with the gas storage portion GS of the second tank 422. The controller 50 adjusts the pressure in the second tank 422 by the back pressure pump 4431 provided to the second gas channel 443. Thus, the controller 50 applies an appropriate negative pressure to the nozzles of the inkjet head 24a to form head menisci. Thus, the controller 50 prevents ink from leaking out from the nozzles at timings other than image formation and maintenance.

### [Third Gas Channel]

The third gas channel 444 is provided on the discharge side of the pneumatic pump 441. The third gas channel 444 communicates with the first gas channel 442 and the second gas channel 443. The third gas channel 444 is provided with a buffer tank 4441.

### <Buffer Tank>

The buffer tank 4441 stores air pressurized by the pneumatic pump 441. The capacity of the buffer tank 4441 is, for example, about 40 ml.

### [Atmospheric Relief Valves]

The atmospheric relief valves 445 are electromagnetic valves configured to be opened and closed under the control of the controller 50, and are provided to the gas channel 44. With the atmospheric relief valves 445, the gas channel 44 and the tanks 42 communicating with the gas channel 44 are selectively opened and closed to the atmosphere. The atmospheric relief valves 445 include a first atmospheric relief valve 4451, a second atmospheric relief valve 4452, a common atmospheric relief valve 4453, and a third atmospheric relief valve 4454.

### <First Atmospheric Relief Valve>

The first atmospheric relief valve 4451 is provided to the first gas channel 442. In a normal state, the first atmospheric relief valve 4451 is opened, and the gas storage portion GS of the first tank 421 and the first gas channel 442 are opened to the atmosphere.

### <Second Atmospheric Relief Valve>

The second atmospheric relief valve 4452 is provided to the second gas channel 443 on the suction side of the back pressure pump 4431. The second atmospheric relief valve 4452 is opened when the back pressure pump 4431 is driven.

### <Common Atmospheric Relief Valve>

The common atmospheric relief valve 4453 is provided between the pneumatic pump 441 and the buffer tank 4441 in the third gas channel 444. The common atmospheric relief valve 4453 is closed while the inkjet heads 24a is operating. The common atmospheric relief valve 4453 is opened in the maintenance of the inkjet recording apparatus 1.

### <Third Atmospheric Relief Valve>

The third atmospheric relief valve 4454 is provided between the buffer tank 4441 and the second gas channel 443 in the third gas channel 444. The third atmospheric relief valve 4454 is closed except in the ejection maintenance.

### (Controller)

FIG. 3 is a block diagram of the internal configuration of the inkjet recording apparatus 1.

The controller 50 controls the components constituting the inkjet recording apparatus 1. As shown in FIG. 3, the controller 50 is connected to the components constituting the inkjet recording apparatus 1. The controller 50 includes a central processing unit (CPU) 51, a random access memory (RAM) 52, and a read only memory (ROM) 53.

The CPU 51 reads various programs and data corresponding to processing contents from a storage device, such as the ROM 53, and executes processing. The CPU 51 controls the operation of the components of the inkjet recording apparatus 1 according to the executed processing. The RAM 52 temporarily stores various programs and data, which are processed by the CPU 51. The ROM 53 stores various programs and data, which are read by the CPU 51 or the like.

As illustrated in FIG. 3, the gas channel 44 and the controller 50 constitute a pressure adjustment apparatus 100 that adjusts pressures of the gas channel 44 in the ejection maintenance process and the circulation maintenance process, which are described later.

### [Ejection Maintenance Process]

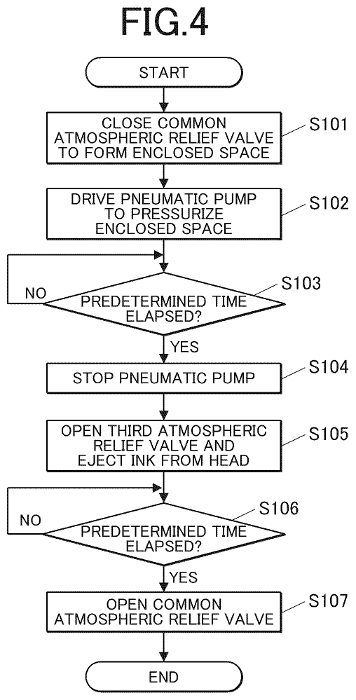

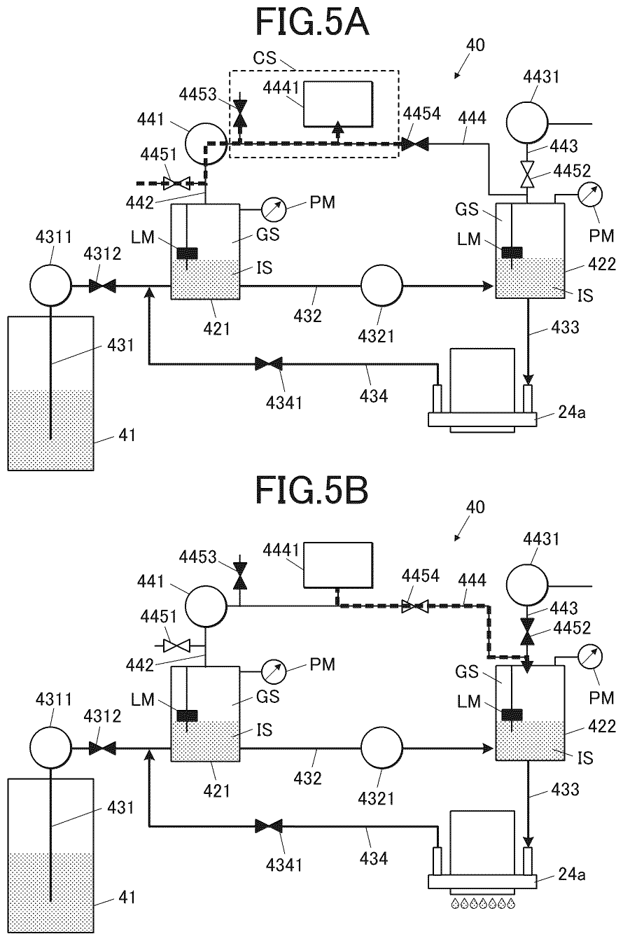

The ink ejection maintenance process by the inkjet recording apparatus 1 having the above configuration is described with reference to FIG. 4 to FIG. 5B. FIG. 4 is a flowchart of the ejection maintenance process as an example.

First, the controller 50 closes the common atmospheric relief valve 4453 and the third atmospheric relief valve 4454 to form an enclosed space in the third gas channel 444 (step S101). Hereinafter, the enclosed space in the third gas channel 444 when the common atmospheric relief valve 4453 is closed is referred to as an enclosed space CS, as shown in FIG. 5A.

The controller 50 drives the pneumatic pump 441 (step S102). In step S102, as shown in FIG. 5A, the first atmospheric relief valve 4451 is in the open state. Therefore, when the pneumatic pump 441 is driven, the atmosphere is sucked through the first atmospheric relief valve 4451, so that the first tank 421 remains at the atmospheric pressure. On the other hand, the enclosed space CS, which is formed in the third gas channel 444 at the discharge side of the pneumatic pump 441, is pressurized.

The controller 50 waits for a predetermined period from the start of driving of the pneumatic pump 441 (step S103). After the predetermined time has elapsed (step S103; Yes), the controller 50 stops the pneumatic pump 441 (step S104). The controller 50 then opens the third atmospheric relief valve 4454. As a result, as shown in FIG. 5B, the pressurized air in the enclosed space CS flows into the second tank 422, thereby applying a pressure to the inside of the second tank 422. Accordingly, ink is ejected from the inkjet head 24a communicating with the second tank 422 (step S105).

The controller 50 waits for a predetermined period from the opening of the third atmospheric relief valve 4454 (step S106). After the predetermined time has elapsed (step S106: YES), the controller 50 opens the common atmospheric relief valve 4453 (step S107). As a result, the pressure in the second tank 422 is released. The controller 50 then opens the back pressure valve 4452 and drives the back pressure pump 4431 to reapply a predetermined negative pressure to the inside of the second tank 422.

According to such an ejection maintenance process, foreign matters and air bubbles in the inkjet head 24a and ink solidified in the nozzles can be ejected outside the inkjet head 24a.

### [Circulation Maintenance Process]

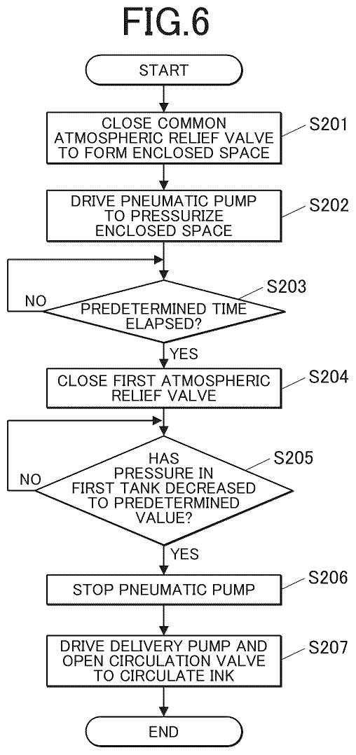

Next, the ink circulation maintenance process by the inkjet recording apparatus 1 having the above configuration is described with reference to FIG. 6 to FIG. 9B. FIG. 6 is a flowchart showing an example of the circulation maintenance process.

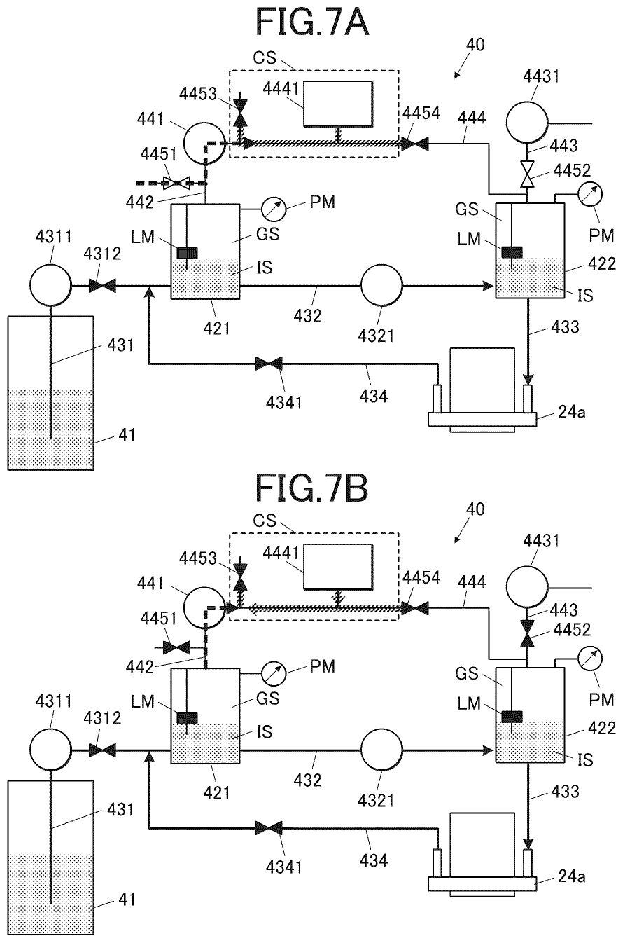

First, the controller 50 closes the common atmospheric relief valve 4453 and the third atmospheric relief valve 4454 to form the enclosed space CS (step S201). The controller 50 also drives the pneumatic pump 441. In step S201, as shown in FIG. 7A, the first atmospheric relief valve 4451 is in the open state. Therefore, as with the ejection maintenance process, the inside of the first tank 421 remains at the atmosphere pressure, and the enclosed space CS is pressurized (step S202).

The controller 50 waits for a predetermined period from the start of driving of the pneumatic pump 441 until the pressure in the enclosed space CS reaches a limit pressure (step S203). After the predetermined period has elapsed (step S203; Yes), the controller 50 closes the first atmospheric relief valve 4451 (step S204). The controller 130 continues driving the pneumatic pump 441 until the value measured by the pressure measurer PM of the first tank 421, namely the inner pressure of the first tank 421, is decreased to a predetermined value (step S205).

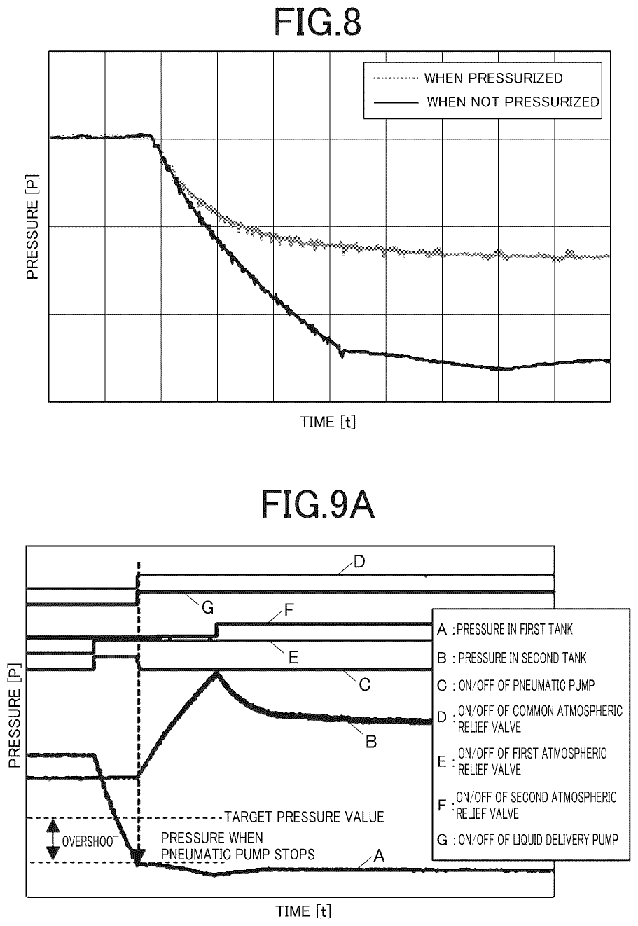

When the first atmospheric relief valve 4451 is closed in step S204, the pneumatic pump 441 starts sucking the gas in the first tank 421. Accordingly, the pressure in the first tank 421 decreases. However, by the pressure resistance of the enclosed space CS, which is pressurized in Step S202, the suction force of the pneumatic pump 441 decreases compared to when the common atmospheric relief valve 4453 is open (i.e., when the sealed space Cs is not pressurized), as shown in FIG. 7B. Therefore, as shown in FIG. 8, the negative pressure generation speed in the first tank 421 is lower than that when the sealed space Cs is not pressurized. As a result, the pressure in the first tank 421 can be precisely controlled even if the pneumatic pump 441 is a high-output pump.

Referring back to FIG. 6, when the pressure value in the first tank 421 decreases to the predetermined value (step S205; Yes), the controller 50 stops the pneumatic pump 441 (step S206). The controller 50 then drives the liquid delivery pump 4321 in a state where the back pressure valve 4452 is closed, and opens the circulation valve 4341. Thus, ink circulates in the liquid delivery section 40 (step S207).

Such a circulation maintenance process can reduce problems, such as viscosity changes and component separation of ink not ejected from the inkjet head 24a.

### Advantageous Effects of Present Embodiment

In a known circulation maintenance process, the pneumatic pump 441 is driven in a state where the common atmospheric relief valve 4453 is open, and the first atmospheric relief valve 4451 is closed from the beginning. Then, when the pressure value in the first tank 421 reaches a predetermined value, the liquid delivery pump 4321 is driven to circulate ink.

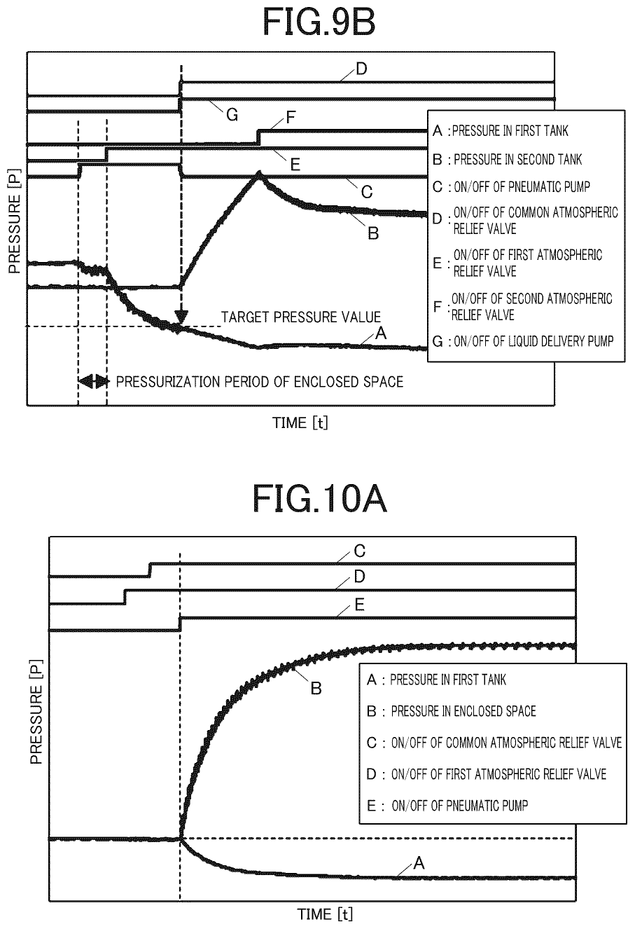

However, when the inside of the first tank 421 is depressurized by the large-sized pneumatic pump 441 having a large air flow rate, the pressure in the first tank 421 becomes negative too quickly after the start of driving of the pneumatic pump 441. As a result, as illustrated in FIG. 9A, an overshoot may occur after the pressure in the first tank 421 measured by the pressure measurer PM of the first tank 421 reaches a predetermined value until the pneumatic pump 441 is stopped. If the circulation valve 4341 is opened while the first tank 421 has an excessively high negative pressure, ink may be rapidly sucked into the first tank 421, destroying menisci of the inkjet head 24a.

On the other hand, in the ink circulation process according to the present embodiment, as shown in FIG. 9B, the controller 50 controls the opening and closing of the atmospheric relief valves 445 when driving the pneumatic pump 441 to form the enclosed space CS in the third gas channel 444, which is on the discharge side of the pneumatic pump 441. After adjusting the pressure of the enclosed space CS, the controller 50 adjusts the pressure of the other side of the pneumatic pump 441, that is, the first gas channel 442 on the gas suction side of the pneumatic pump 441. According to the above configuration, even if the pneumatic pump 441 is large-sized for ink ejection maintenance of the inkjet head 24a, the pressure in the first tank 421 can be precisely controlled by the pressure resistance of the enclosed space CS. Furthermore, according to the above configuration, the pressure in the first tank 421 can be precisely controlled regardless of the air capacity of the first tank 421. Accordingly, the pressure adjustment apparatus 100 and the inkjet recording apparatus 1 can be downsized.

### [Other Configurations]

Although the present invention has been described in detail based on the embodiment, the present invention is not limited to the above-described embodiment. Of course, various modifications are possible within the scope of the invention described in the claims and their equivalents.

For example, in step S203 of the above description, the first atmospheric relief valve 4451 is closed after the predetermined time elapses from the start of driving the pneumatic pump 441. However, the present invention is not limited thereto. For example, the controller 50 may close the first atmospheric relief valve 4451 at the timing of closing the common atmospheric relief valve 4453 in step S201. In such a configuration, the enclosed space CS is formed by closing the common atmospheric relief valve 4453, and the enclosed space CS is pressurized. Thus, the suction pressure of the pneumatic pump 441 can be controlled in the same manner as the above description.

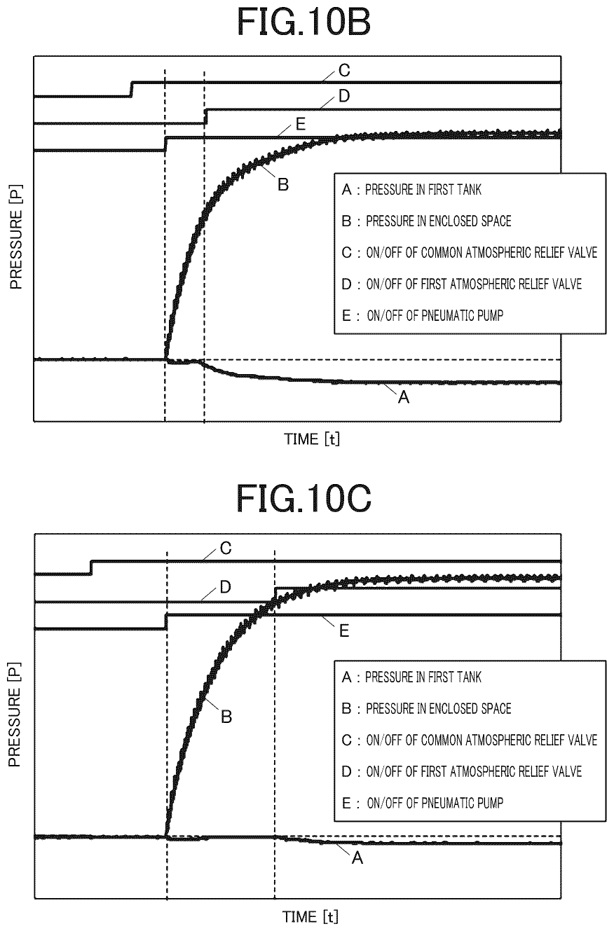

However, as the time from the start of the driving of the pneumatic pump 441 to the closing of the first atmospheric relief valve 4451 becomes longer, the pressure value in the enclosed space CS increases, so that the pressure value in the first tank 421 gradually decreases. Specific examples are illustrated in FIG. 10A to FIG. 10C. FIG. 10A is a graph showing changes of the pressure in the first tank 421 in a case where the first atmospheric relief valve 4451 is closed before the start of driving of the pneumatic pumps 441. FIG. 10B is a graph showing changes of the pressure in the first tank 421 in a case where the first atmospheric relief valve 4451 is closed after a predetermined period elapses from the start of driving of the pneumatic pump 441. FIG. 10C is a graph showing changes of the pressure in the first tank 421 in a case where the first atmospheric relief valve 4451 is closed after a predetermined time that is longer than in FIG. 10B elapses from the start of driving of the pneumatic pump 441.

In the above description, in step S204, the first atmospheric relief valve 4451 is closed after a predetermined time elapses from the start of driving of the pneumatic pump 441. However, the present invention is not limited thereto. The pressure measurer PM may be provided as a pressure detector in the third gas channel 444, and the controller 50 may close the first atmospheric relief valve 4451 when the value measured by the pressure measurer PM reaches a predetermined value.

Similarly, the liquid level measurer LM may be provided as an air amount detector, and the controller 50 may close the first atmospheric relief valve 4451 when the value measured by the air amount detector reaches a predetermined value. Specifically, the controller 50 can calculate the amount of air in the first tank 421 by the following: The capacity of the first tank 421—The measurement result of the liquid level measurer LM.

Furthermore, although the value measured by the pressure measurer PM of the first tank 421 is used in step S205 in the description above, the present invention is not limited thereto. That is, the lower limit of the pressure value in the first tank 421 may be adjusted to a preferable predetermined value in the ink circulation maintenance by adjusting the pressure applied to the enclosed space CS. In such a configuration, the pressure measurer PM may not be provided in the first tank 421.

Further, although the droplet ejection apparatus is the inkjet recording apparatus 1 in the above embodiment, the invention is not limited thereto. The present invention may be applied to various droplet ejection apparatuses that eject droplets other than ink from nozzles.

Although a hard disk, a semiconductor nonvolatile memory, or the like is used in the above description as a computer-readable medium storing the program according to the present invention, the present invention is not limited to this. As another computer-readable medium, a portable recording medium such as a CD-ROM can be applied. Furthermore, a carrier wave is also applied as a medium for providing data of the program according to the present invention via a communication line.

Although embodiments of the present invention have been described and illustrated in detail, the disclosed embodiments are made for purposes of illustration and example only and not limitation. The scope of the present invention should be interpreted by terms of the appended claims.

What is claimed is:

1. A pressure adjustment apparatus comprising:
a gas channel configured to form an enclosed space, the gas channel including a suction-side gas channel at a suction side of a pneumatic pump and a discharge-side gas channel at a discharge side of the pneumatic pump;
the pneumatic pump provided to the gas channel and configured to send gas from the suction side to the discharge side;
atmospheric relief valves including at least one suction-side atmospheric relief valve and at least one discharge-side atmospheric relief valve, the suction-side atmospheric relief valve being provided to the suction-side gas channel and configured to open and close the suction-side gas channel to atmosphere, the discharge-side atmospheric relief valve being provided to the discharge-side gas channel and configured to open and close the discharge-side gas channel to atmosphere; and
a hardware processor, wherein
in driving the pneumatic pump, the hardware processor controls opening and closing of the atmospheric relief valves to firstly adjust a pressure in the enclosed space formed in one of the suction-side gas channel and the discharge-side gas channel and secondly adjust a pressure in another of the suction-side gas channel and the discharge-side gas channel.

2. The pressure adjustment apparatus according to claim 1, wherein
the hardware processor adjusts the pressure in the enclosed space formed in the suction-side air channel by closing the suction-side atmospheric relief valve.

3. The pressure adjustment apparatus according to claim 2, wherein
the hardware processor closes the suction-side atmospheric relief valve after a predetermined period elapses from a start of driving of the pneumatic pump.

4. The pressure adjustment apparatus according to claim 2, further comprising an air amount detector configured to detect an amount of air in at least either the suction-side gas channel or the discharge-side gas channel,
wherein the hardware processor closes the suction-side atmospheric relief valve, based on a detection result of the air amount detector.

5. The pressure adjustment apparatus according to claim 2, further comprising a pressure detector configured to detect a pressure in the enclosed space,
wherein the hardware processor closes the suction-side atmospheric relief valve, based on a detection result of the pressure detector.

6. The pressure adjustment apparatus according to claim 1, wherein the pneumatic pump is a diaphragm pump.

7. A droplet ejection apparatus comprising:
the pressure adjustment apparatus according to claim 1;
a tank that communicates with the suction-side gas channel and that stores liquid;
a liquid channel configured to deliver the liquid from the tank; and
a droplet ejection head configured to eject droplets of the liquid delivered by the tank,
wherein the hardware processor adjusts a pressure in the tank by adjusting a pressure in the suction-side gas channel.

8. A pressure adjustment method for a pressure adjustment apparatus that includes:
a gas channel configured to form an enclosed space, the gas channel including a suction-side gas channel at a suction side of a pneumatic pump and a discharge-side gas channel at a discharge side of the pneumatic pump;
the pneumatic pump provided to the gas channel and configured to send gas from the suction side to the discharge side; and
atmospheric relief valves including at least one suction-side atmospheric relief valve and at least one discharge-side atmospheric relief valve, the suction-side atmospheric relief valve being provided to the suction-side gas channel and configured to open and close the suction-side gas channel to atmosphere, the discharge-side atmospheric relief valve being provided to the discharge-side gas channel and configured to open and close the discharge-side gas channel to atmosphere,
wherein the method comprises firstly adjusting a pressure in the enclosed space formed in one of the suction-side gas channel and the discharge-side gas channel and secondly adjusting a pressure in another of the suction-side gas channel and the discharge-side gas channel by controlling opening and closing of the atmospheric relief valves in driving the pneumatic pump.

9. The pressure adjustment method according to claim 8, wherein
the pressure in the enclosed space formed in the suction-side air channel is adjusted by closing the suction-side atmospheric relief valve.

10. The pressure adjustment method according to claim 9, wherein
the suction-side atmospheric relief valve is closed after a predetermined period elapses from a start of driving of the pneumatic pump.

11. The pressure adjustment method according to claim 9, wherein
the pressure adjustment apparatus further includes an air amount detector configured to detect an amount of air in at least either the suction-side gas channel or the discharge-side gas channel; and
the suction-side atmospheric relief valve is closed, based on a detection result of the air amount detector.

12. The pressure adjustment method according to claim 9, wherein
the pressure adjustment apparatus further includes a pressure detector configured to detect a pressure in the enclosed space; and
the suction-side atmospheric relief valve is closed, based on a detection result of the pressure detector.

13. A non-transitory computer-readable storage medium storing a program for a computer of a pressure adjustment apparatus that includes:
a gas channel configured to form an enclosed space, the gas channel including a suction-side gas channel at a suction side of a pneumatic pump and a discharge-side gas channel at a discharge side of the pneumatic pump;
the pneumatic pump provided to the gas channel and configured to send gas from the suction side to the discharge side; and
atmospheric relief valves including at least one suction-side atmospheric relief valve and at least one discharge-side atmospheric relief valve, the suction-side atmospheric relief valve being provided to the suction-side gas channel and configured to open and close the suction-side gas channel to atmosphere, the discharge-side atmospheric relief valve being provided to the discharge-side gas channel and configured to open and close the discharge-side gas channel to atmosphere,
wherein the program causes the computer to firstly adjust a pressure in the enclosed space formed in one of the suction-side gas channel and the discharge-side gas channel and secondly adjust a pressure in another of the suction-side gas channel and the discharge-side gas channel by controlling opening and closing of the atmospheric relief valves in driving the pneumatic pump.
